(19) United States
(12) Patent Application Publication
(10) Pub. No.: US 2017/0001456 A1
(43) Pub. Date: Jan. 5, 2017

(54) RECORDING APPARATUS

(71) Applicant: SEIKO EPSON CORPORATION, Tokyo (JP)

(72) Inventors: Toshio NAKATA, Matsumoto (JP); Yuya ISHIKAWA, Matsumoto (JP)

(21) Appl. No.: 15/112,667

(22) PCT Filed: Dec. 16, 2014
(86) PCT No.: PCT/JP2014/006270

§ 371 Date: Jul. 19, 2016

(30) Foreign Application Priority Data
Jan. 20, 2014 (JP) 2014-007854

(51) Int. Cl. B41J 15/04

(52) U.S. Cl. CPC B41J 15/04

(57) ABSTRACT

The present invention relates to a recording apparatus which includes: a set portion in which a roll-shaped recording medium is set; a transporting portion of the recording medium; a medium supporting portion which supports the recording medium; and a contact portion which is provided between the set portion and the medium supporting portion in a transporting direction of the recording medium and is biased to come into contact with the recording medium.

### TECHNICAL FIELD

The present invention relates to a recording apparatus.

### BACKGROUND ART

In the related art, a recording apparatus which can perform recording on a recording medium is used. In addition, among the recording apparatuses, a recording apparatus which can perform recording on a roll-shaped recording medium is often used.

For example, in PTL 1, a recording apparatus is disclosed which is provided with a platen as a medium supporting portion which can heat the roll-shaped recording medium before recording by a recording portion is performed.

### CITATION LIST

### Patent Literature

PTL 1: JP-A-2013-52578

### SUMMARY OF INVENTION

### Technical Problem

However, in a recording apparatus which can perform recording on a roll-shaped recording medium, when the interval between a set portion of the recording medium and a medium supporting portion is large and humidity is high in an installation location of the recording apparatus, a deformation, such as moisture absorption and wrinkling (cockling), is generated when the recording medium is transported over the interval.

Here, it is an object of the present invention to suppress moisture absorption and deformation of the recording medium in a recording apparatus which can perform recording on a roll-shaped recording medium.

### Solution to Problem

According to a first aspect of the present invention to solve the above-described problem, there is provided a recording apparatus including: a set portion of a roll-shaped recording medium; a transporting portion of the recording medium; a medium supporting portion which supports the recording medium; and a contact portion which is provided between the set portion and the medium supporting portion in a transporting direction of the recording medium and is biased to come into contact with the recording medium.

According to the aspect, between the set portion and the medium supporting portion in the transporting direction of the recording medium, a contact portion which is biased to come into contact with the recording medium is provided. For this reason, even when humidity is high in an installation location of the recording apparatus, as the contact portion comes into contact with the recording medium, the moisture absorption of the recording medium is suppressed in an interval between the set portion and the medium supporting portion. Therefore, it is possible to suppress moisture absorption and deformation of the recording medium. In addition, since the contact portion is biased to come into contact with the recording medium, it is possible to reduce a concern that the contact portion is separated from the recording medium.

According to the recording apparatus of a second aspect of the present invention, in the first aspect, the contact portion has moisture impermeability.

Here, the term “moisture impermeability” means that it is sufficient if permeation of vapor can be blocked to the extent that the moisture absorption of the recording medium is suppressed as the contact portion comes into contact with the recording medium, and means that the permeation of the vapor in the air is not required to be completely suppressed.

According to the aspect, since the contact portion has moisture impermeability, it is possible to effectively suppress moisture absorption and deformation of the recording medium.

According to the recording apparatus of a third aspect of the present invention, in the first or the second aspect, the contact portion has flexibility.

According to the aspect, since the contact portion has flexibility, the contact portion is easily brought into contact with the recording medium, and the contact portion is simply configured.

According to the recording apparatus of a fourth aspect of the present invention, in any one of the first to the third aspects, the contact portion is made of fluorine at a contact part between the contact portion and the recording medium.

According to the aspect, the contact portion is made of fluorine at the contact part between the contact portion and the recording medium. For this reason, it is possible to alleviate a friction force between the contact part and the recording medium, and to suppress deterioration of transporting accuracy of the recording medium.

According to the recording apparatus of a fifth aspect of the present invention, in any one of the first to the fourth aspects, the contact portion is attachable and detachable.

Among roll-shaped recording media, in the recording medium which has a releasing paper sheet on a side reverse to a recording surface on which the recording is performed, the releasing paper sheet is likely to absorb moisture, and particularly, is likely to be deformed. Meanwhile, in addition to such a recording medium, there is also a recording medium which is unlikely to absorb moisture and is unlikely to be deformed.

According to the aspect, it is possible to put the contact portion when the recording is performed on the recording medium which is likely to absorb moisture and is likely to be deformed, and to take off the contact portion when the recording is performed on the recording medium which is unlikely to absorb moisture and is unlikely to be deformed. For this reason, by attaching and detaching the contact portion according to the recording medium to be used, it is possible to suppress deformation of the recording medium and to suppress deterioration of transporting accuracy.

The recording apparatus of a sixth aspect of the present invention, in any one of the first to the fifth aspects, further includes a recording portion which performs recording on the recording medium, the medium supporting portion includes a pre-heating area in which the recording medium is heated before the recording is performed by the recording portion, and the contact portion is attached to the pre-heating area.

According to the aspect, the contact portion is attached to the pre-heating area. For this reason, in the recording apparatus which has the pre-heating area, it is possible to effectively utilize space, and to make the recording apparatus compact.

According to the recording apparatus of a seventh aspect of the present invention, in any one of the first to the sixth aspects, the contact part between the contact portion and the recording medium in the contact portion, and a contact part between the medium supporting portion and the recording medium in the medium supporting portion, are surface-treated in a similar manner.

According to the aspect, the contact part between the contact portion and the recording medium in the contact portion, and the contact part between the medium supporting portion and the recording medium in the medium supporting portion, are similarly surface-treated. For this reason, a charged state of the recording medium changes when the recording medium moves from the contact part in the contact portion to the contact part in the medium supporting portion, and thus, it is possible to suppress deterioration of image quality which is recorded by the recording portion.

In addition, “similar surface treatment” does not mean that exactly the same surface treatment is required to be performed, but means the surface treatment which is different to the extent that the charged state of the recording medium is not changed causing deterioration of the image quality when the recording medium moves from the contact part in the contact portion to the contact part in the medium supporting portion.

According to the recording apparatus of an eighth aspect of the present invention, in any one of the first to the seventh aspects, the length of the transporting direction in the contact portion is 50% to 95% of the distance between the recording medium which is set in the set portion and the medium supporting portion.

According to the aspect, the length of the transporting direction in the contact portion is 50% to 95% of the distance between the recording medium which is set in the set portion and the medium supporting portion. For this reason, the recording medium which is set in the set portion and the contact portion are suppressed not to come into contact with each other. At the same time, the contact portion can immediately come into contact with the recording medium which is extracted from the roll-shaped recording medium, and it is possible to suppress moisture absorption in the recording medium.

### BRIEF DESCRIPTION OF DRAWINGS

FIG. 1 is a schematic side surface view illustrating a recording medium according to one embodiment of the present invention.

FIG. 2 is a schematic perspective view illustrating the recording medium according to the embodiment of the present invention.

FIG. 3A is a view illustrating the order when a contact portion is attached to the recording apparatus according to the embodiment of the present invention.

FIG. 3B is a view illustrating the order when the contact portion is attached to the recording apparatus according to the embodiment of the present invention.

FIG. 3C is a view illustrating the order when the contact portion is attached to the recording apparatus according to the embodiment of the present invention.

FIG. 4 is a schematic perspective view illustrating an attachment portion of the contact portion in the recording apparatus according to the embodiment of the present invention.

FIG. 5 is a schematic perspective cross-sectional view illustrating the attachment portion of the contact portion in the recording apparatus according to the embodiment of the present invention.

FIG. 6 is a schematic side surface cross-sectional view illustrating the attachment portion of the contact portion in the recording apparatus according to the embodiment of the present invention.

FIG. 7 is a schematic perspective view illustrating the attachment portion of the contact portion in the recording apparatus according to the embodiment of the present invention.

FIG. 8 is a schematic perspective cross-sectional view illustrating the attachment portion of the contact portion in the recording apparatus according to the embodiment of the present invention.

FIG. 9 is a schematic side surface cross-sectional view illustrating the attachment portion of the contact portion in the recording apparatus according to the embodiment of the present invention.

FIG. 10 is a schematic perspective view illustrating the attachment portion of the contact portion in the recording apparatus according to the embodiment of the present invention.

FIG. 11 is a schematic perspective view illustrating a pressure portion of the attachment portion of the contact portion in the recording apparatus according to the embodiment of the present invention.

FIG. 12 is a schematic perspective view illustrating the pressure portion of the attachment portion of the contact portion in the recording apparatus according to the embodiment of the present invention.

### DESCRIPTION OF EMBODIMENT

Hereinafter, a recording apparatus according to one embodiment of the present invention will be described in detail with reference to the attached drawings.

### Embodiment

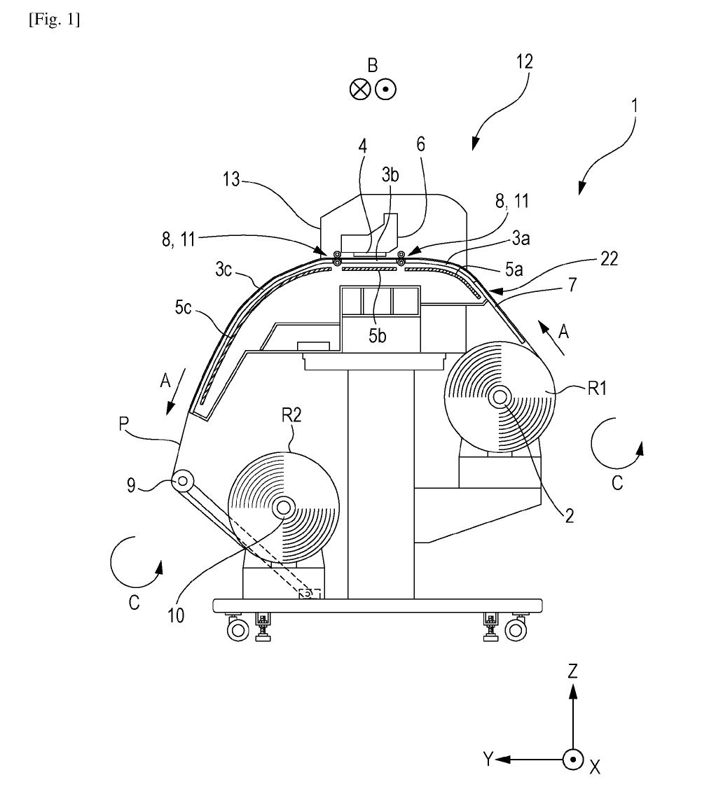

(FIGS. 1 to 12) First, the recording apparatus according to the embodiment of the present invention will be described.

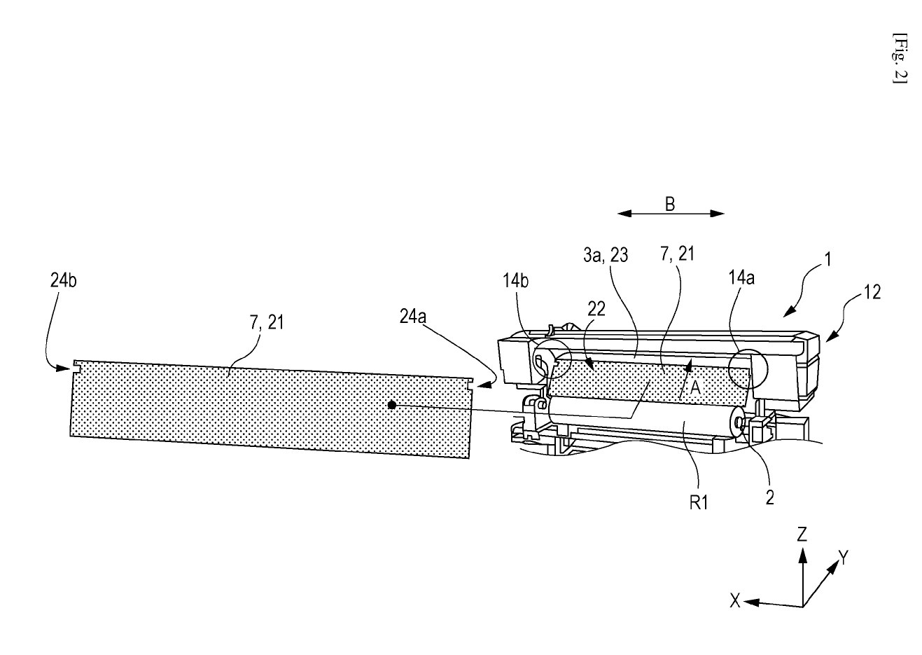

FIG. 1 is a schematic side surface view of a recording apparatus 1 according to one embodiment. FIG. 2 is a schematic perspective view of the recording apparatus 1 according to the embodiment. In addition, FIG. 2 also illustrates a state where a contact portion 7 is detached.

The recording apparatus 1 according to the embodiment is provided with a set portion 2 which sets a roll R1 of a roll-shaped recording medium P for performing recording. In the recording apparatus 1 of the embodiment, when the roll-shaped recording medium P is transported in a transporting direction A, the rotation axis of the set portion 2 rotates in a rotation direction C. In addition, the roll-type recording medium P which is wound so that a recording surface is an outer side is used in the embodiment. However, when the roll-type recording medium P which is wound so that the recording surface is an inner side is used, it is possible to send out the roll R1 by rotating opposite to the rotation direction C.

In addition, the recording apparatus 1 of the embodiment is provided with a transporting mechanism 11 which includes a pair of transporting rollers 8 as a transporting portion for transporting the recording medium P in the transporting direction A. In addition, at a lower portion of a medium supporting portion 3a which supports the recording medium P, a heater 5a which can perform pre-heating before recording on the recording medium P supported by the medium supporting portion 3a occurs, is provided.

In addition, the recording apparatus 1 of the embodiment is provided with a heater which can heat the recording medium P from the medium supporting portion 3a side, as the heater 5a, but may be provided with an infrared heater which is provided at a position which faces the medium supporting portion 3a.

In addition, the contact portion 7, which extends from an end portion on an upstream side in the transporting direction A toward the upstream side of the transporting direction A, is attached to the medium supporting portion 3a of the embodiment. The contact portion 7 is configured of a material having flexibility, and has a configuration in which the upstream side of the transporting direction A is positioned further upward than in the state illustrated in FIG. 1, in the state where the recording medium P is not set by the elastic force of the contact portion 7. In the state illustrated in FIG. 1 in which the recording medium P is set, the recording medium P which is pushed downward automatically or the like, is pushed back upward by the elastic force, and comes into contact with a surface on the opposite side to the recording surface of the recording medium P.

When described in a different way, the recording apparatus 1 of the embodiment is provided with the set portion 2 of the roll-shaped recording medium P, the pair of transporting rollers 8 which transports the recording medium P, the medium supporting portion 3a which supports the recording medium P, and the contact portion 7 which is provided between the set portion 2 and the medium supporting portion 3a in the transporting direction A of the recording medium P and which is biased to come into contact with the recording medium P.

For this reason, even when a humidity is high in an installation location of the recording apparatus 1, since the contact portion 7 comes into contact with the recording medium P, it is possible to suppress moisture absorption of the recording medium P from the opposite side to the recording surface in the interval between the set portion 2 and the medium supporting portion 3a. Therefore, it is possible to suppress moisture absorption and deformation of the recording medium P.

In addition, as the contact portion 7 is biased with respect to the recording medium P, even when a position of the recording medium P which comes into contact with the contact portion 7 in a vertical direction is changed, it is possible to minor the change of the position and to change the position of the contact portion 7. Therefore, it is possible to reduce the concern that the contact portion 7 is separated from the recording medium P, and to suppress moisture absorption and deformation of the recording medium P.

In addition, the contact portion 7 of the embodiment is configured of a moisture impermeable plastic sheet, and has moisture impermeability.

Here, the “moisture impermeability” means that it is sufficient if permeation of vapor can be blocked to the extent that the moisture absorption of the recording medium P is suppressed as the contact portion 7 comes into contact with the recording medium P, and means that the permeation of the vapor in the air is not required to be completely suppressed. In addition, as an experiment method of measuring the moisture impermeability, it is possible to employ an experiment method for measuring a vapor permeation level which is defined in JIS K7129. Here, the vapor permeation level is preferable when the level is equal to or less than 20 g per 1 m², for 24 hours.

Since the contact portion 7 of the embodiment has moisture impermeability, the moisture absorption and the deformation of the recording medium P are effectively suppressed.

In addition, the contact portion 7 of the embodiment is configured of a flexible plastic, and has flexibility.

For this reason, the contact portion 7 is easily brought into contact with the recording medium P, and the contact portion 7 is simply configured.

In addition, examples of a preferable configuration material for the contact portion 7 of the embodiment include polyethylene, polypropylene, polystyrene, polycarbonate, or the like, but are not limited thereto.

In addition, in the contact portion 7 of the embodiment, the recording medium P and a contact part 21 are fluorine-coated, and fluorine is provided in the contact part 21.

For this reason, it is possible to alleviate a friction force between the contact part 21 and the recording medium P, and the deterioration of transporting accuracy of the recording medium P is suppressed.

In addition, as illustrated in FIG. 2, the contact portion 7 of the embodiment can be attachable to and detachable from the medium supporting portion 3a.

Among the roll-shaped recording media P, in the recording medium P which has a releasing paper sheet on a side reverse to the recording surface on which the recording is performed, the releasing paper sheet is likely to absorb moisture, and particularly, is likely to be deformed. Meanwhile, in addition to the recording medium P, there is also a recording medium P which is unlikely to absorb moisture and is unlikely to be deformed.

In the recording apparatus 1 of the embodiment, it is possible to put the contact portion 7 when the recording is performed on the recording medium P which is likely to absorb moisture and is likely to be deformed, and to take off the contact portion 7 when the recording is performed on the recording medium P which is unlikely to absorb moisture and is unlikely to be deformed. For this reason, by attaching and detaching the contact portion 7 according to the recording medium P to be used, it is possible to suppress deformation of the recording medium P and to suppress deterioration of transporting accuracy.

In addition, as described above, the medium supporting portion 3a of the embodiment has a pre-heating area 22 which pre-heats the recording medium P with the heater 5a.

As illustrated in FIGS. 1 and 2, the contact portion 7 is attached to the pre-heating area 22.

For this reason, in the recording apparatus 1 having the pre-heating area 22, it is possible to effectively utilize space, and to make the recording apparatus 1 compact.

In addition, in the recording apparatus 1 of the embodiment, the contact part 21 between the contact portion 7 and the recording medium in the contact portion 7, and a contact part 23 between the medium supporting portion 3a and the recording medium P in the medium supporting portion 3a, are similarly surface-treated.

For this reason, a charged state of the recording medium P changes when the recording medium P is transported in the transporting direction A and moves from the contact part 21 in the contact portion 7 to the contact part 23 in the medium supporting portion 3a, and thus, deterioration of image quality which is recorded by a recording head 4 as a recording portion is suppressed.

In addition, “similar surface treatment” does not mean that completely the same surface treatment is required to be performed, but means the surface treatment which is different to the extent that the charged state of the recording medium P is not changed causing deterioration of the image quality when the recording medium P moves from the contact part 21 in the contact portion 7 to the contact part 23 in the medium supporting portion 3a.

In addition, the length in a direction B in the contact portion 7 of the embodiment is configured to be longer than the width of the recording medium P which is assumed to be used. Specifically, in the recording apparatus 1 of the embodiment, the recording medium P having approximately 1626 mm (64 inches) of width is assumed to be used as the largest recording medium P, and the length in the direction B in the contact portion 7 of the embodiment is 1700 mm which is longer than the width thereof.

In addition, according to the width of the recording medium P to be used, the length in the direction B in the contact portion 7 may be configured to be changeable.

In addition, the length of the transporting direction A in the contact portion 7 of the embodiment is approximately 330 mm. In addition, it is preferable that the length of the transporting direction A in the contact portion 7 be 50% to 95% of the distance between the recording medium P which is set in the set portion 2 and the medium supporting portion 3a.

In addition, the “length of the transporting direction A in the contact portion 7” is referred to as the length from a position of the contact portion 7 which is positioned at the end portion of the upstream side in the transporting direction of the medium supporting portion 3a, to the position of the end portion of the contact portion 7 which is positioned on the upstream side in the transporting direction in the contact portion 7. In addition, the “length of the transporting direction A in the contact portion 7” is also referred to as the length in the transporting direction of an area (area which does not come into contact with the medium supporting portion 3a) where the contact portion 7 independently exists.

In this manner, since the length of the transporting direction A in the contact portion 7 is 50% to 95% of the distance between the recording medium P which is set in the set portion 2 and the medium supporting portion 3a, compared to a case where the length of the transporting direction A in the contact portion 7 is equal to or greater than 95% of the distance between the recording medium P which is set in the set portion 2 and the medium supporting portion 3a, it is possible to suppress contact between the contact portion 7 and the recording surface of the recording medium P which is set in the set portion 2. Therefore, it is possible to reduce the concern that the recording surface will be damaged.

In addition, since the length of the transporting direction A in the contact portion 7 is 50% to 95% of the distance between the recording medium P which is set in the set portion 2 and the medium supporting portion 3a, compared to a case where the length of the transporting direction A in the contact portion 7 is less than 50% of the distance between the recording medium P which is set in the set portion 2 and the medium supporting portion 3a, it is possible to cause area where the recording medium P and the contact portion 7 come into contact with each other to be large, and to suppress moisture absorption and deformation of the recording medium P.

In addition, in the recording apparatus 1 of the embodiment, the contact portion 7 can be attached to the medium supporting portion 3a so that the medium supporting portion 3a and the contact portion 7 are overlapped with each other in the transporting direction A. This is because the medium supporting portion 3a can securely support the contact portion 7 as the medium supporting portion 3a and the contact portion 7 are overlapped with each other in the transporting direction A.

In addition, in the recording apparatus 1 of the embodiment, a recording mechanism 12 is provided which mounts the recording head 4 on a carriage 6 and reciprocatively scans the recording head 4 as a recording portion in the direction B which intersects with the transporting direction A of the recording medium P, and which performs recording by discharging ink from each nozzle on a nozzle surface provided with a plurality of nozzles.

In addition, a direction X and a direction Y in the drawings are horizontal directions, and a direction Z in the drawings is a vertical direction. Here, the direction B corresponds to the direction X, and the transporting direction A of the recording medium P at a position which faces the recording head 4 corresponds to the direction Y. However, the invention is not limited to this configuration.

In addition, the recording apparatus 1 of the embodiment is provided with the recording head 4 which performs recording while moving reciprocatively. However, the recording apparatus 1 of the embodiment may be a recording apparatus which is provided with a so-called line head that has a plurality of nozzles which discharge the ink provided in a direction which intersects the transporting direction A.

Here, the “line head” is a recording head in which an area of nozzles formed in the direction B which intersects the transporting direction A of the recording medium P is provided so that the entire range in the direction B of the recording medium P can be covered, and which is used in the recording apparatus that forms an image by fixing the recording head or one side of the recording medium and moving the other side of the recording medium. In addition, the area of nozzles of the direction B of the line head may not be able to cover the entire range in the direction B of the entire recording medium P to which the recording apparatus corresponds.

Furthermore, a recording apparatus, which has a recording portion other than the so-called ink jet type recording head as described above, may be employed.

In addition, in the area which faces the recording head 4, a medium supporting portion 3b which supports the recording medium P is provided. In addition, at a lower portion of the medium supporting portion 3b which supports the recording medium P, a heater 5b which can heat the recording medium P supported by the medium supporting portion 3b during recording is provided.

In addition, the recording apparatus 1 of the embodiment is provided with a heater which can heat the recording medium P from the medium supporting portion 3b side as the heater 5b, but may be provided with an infrared heater which is provided at a position which faces the medium supporting portion 3b. When the infrared heater is used, the preferable wavelength of an infrared ray thereof is 0.76 micrometers to 1000 micrometers. In general, the infrared ray is further divided into a near infrared ray, a mid infrared ray, and a far infrared ray, by the wavelength. Definition of division varies, but roughly, the wavelength range is divided into 0.78 micrometers to 2.5 micrometers, 2.5 micrometers to 4.0 micrometers, and 4.0 micrometers to 1000 micrometers. Among these, it is preferable to use the mid infrared ray.

In addition, on a downstream side in the transporting direction A of the recording medium P of the recording mechanism 12, a medium supporting portion 3c which supports the recording medium P is provided. In addition, at a lower portion of the medium supporting portion 3c which supports the recording medium P, a heater 5c which can heat the recording medium P supported by the medium supporting portion 3c in the middle of the recording is provided.

In addition, the recording apparatus 1 of the embodiment is provided with a heater which can heat the recording medium P from the medium supporting portion 3c side as the heater 5c, but may be provided with an infrared heater or the like which is provided at a position which faces the medium supporting portion 3c.

In addition, on the downstream side in the transporting direction A of the recording medium P of the medium supporting portion 3c, a winding portion 10 which can roll up the recording medium P as a roll R2 is provided. In addition, since the recording medium P is rolled up so that the recording surface is the outer side in the embodiment, when the recording medium P is rolled up, the rotation axis of the winding portion 10 rotates in the rotation direction C. Meanwhile, when the recording surface is rolled up so as to be an inner side, it is possible to roll up the recording medium P by rotating the rotation axis opposite to the rotation direction C.

In addition, between an end portion of the downstream side in the transporting direction A of the recording medium P in the medium supporting portion 3 and the winding portion 10, the contact portion which is in contact with the recording medium P is provided in the direction B, and a tension bar 9 which can give a predetermined tension to the recording medium P is provided.

Next, the contact portion 7 and the order when the contact portion 7 is attached to the recording apparatus 1 will be described.

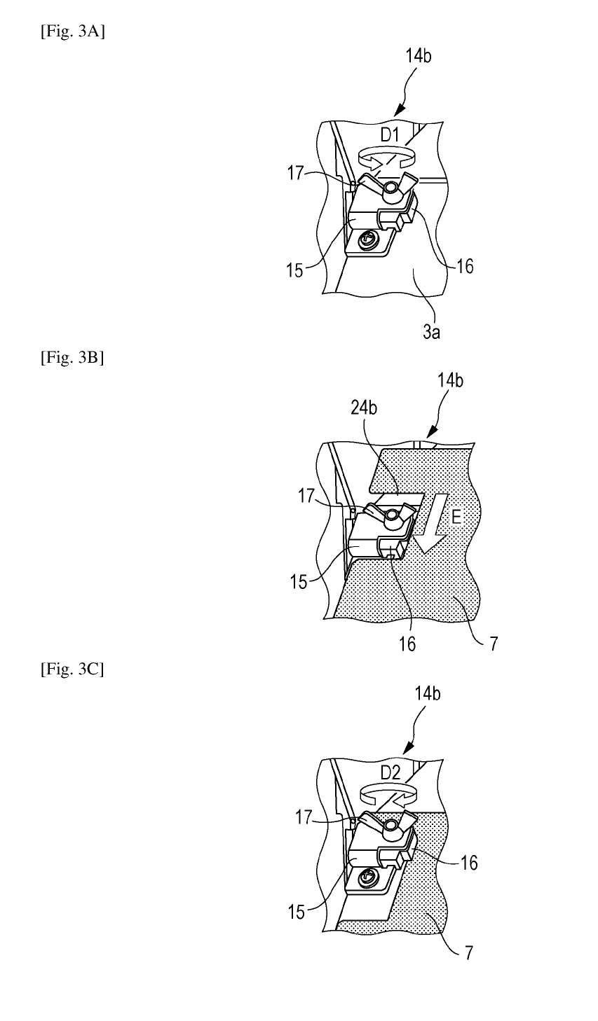

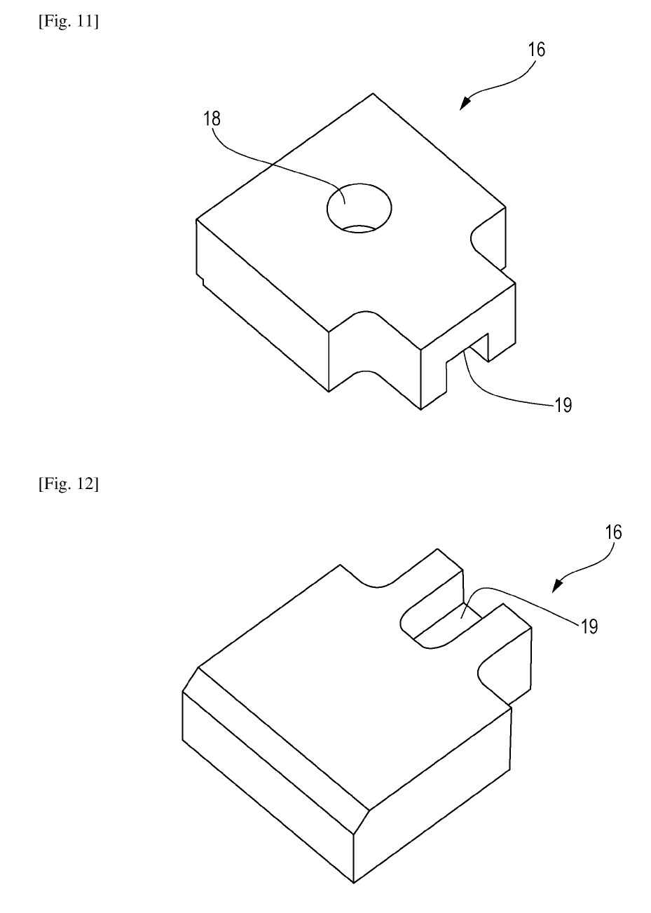

FIGS. 3A to 10 are schematic views illustrating attachment portions 14a and 14b of the contact portion 7. FIGS. 11 and 12 are schematic views illustrating a pressing portion 16 of the attachment portions 14a and 14b.

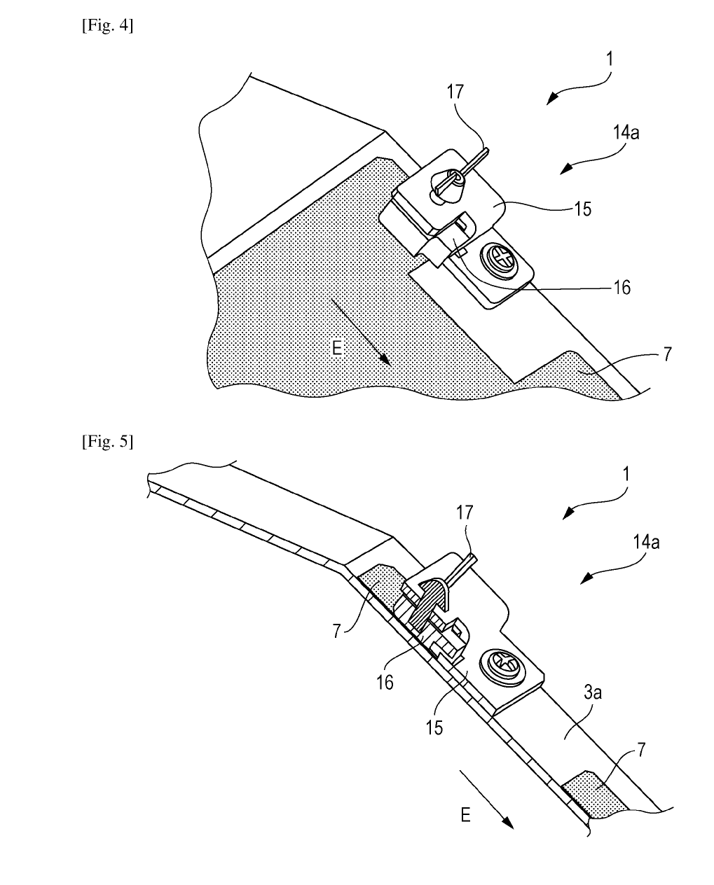

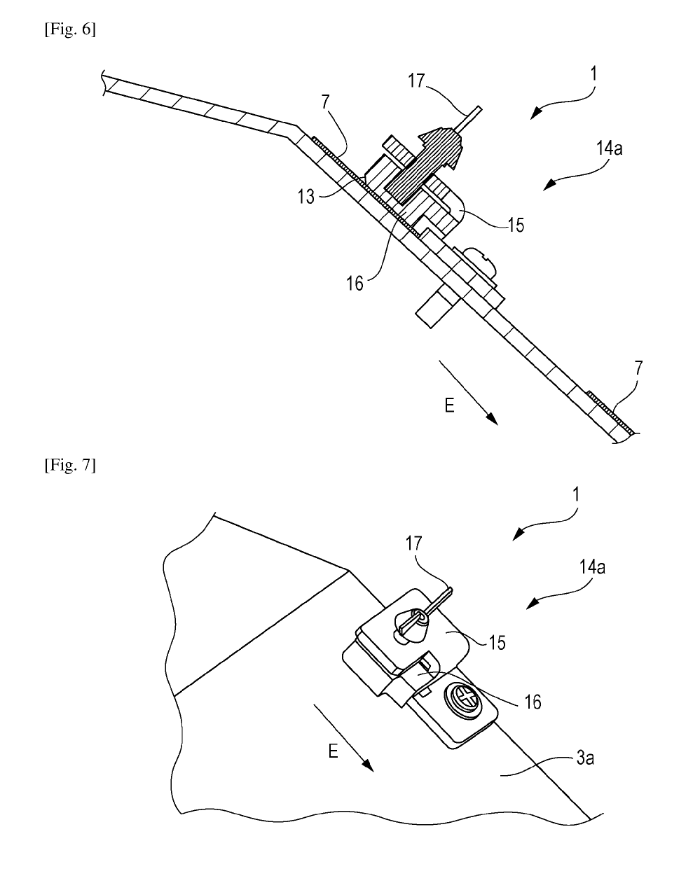

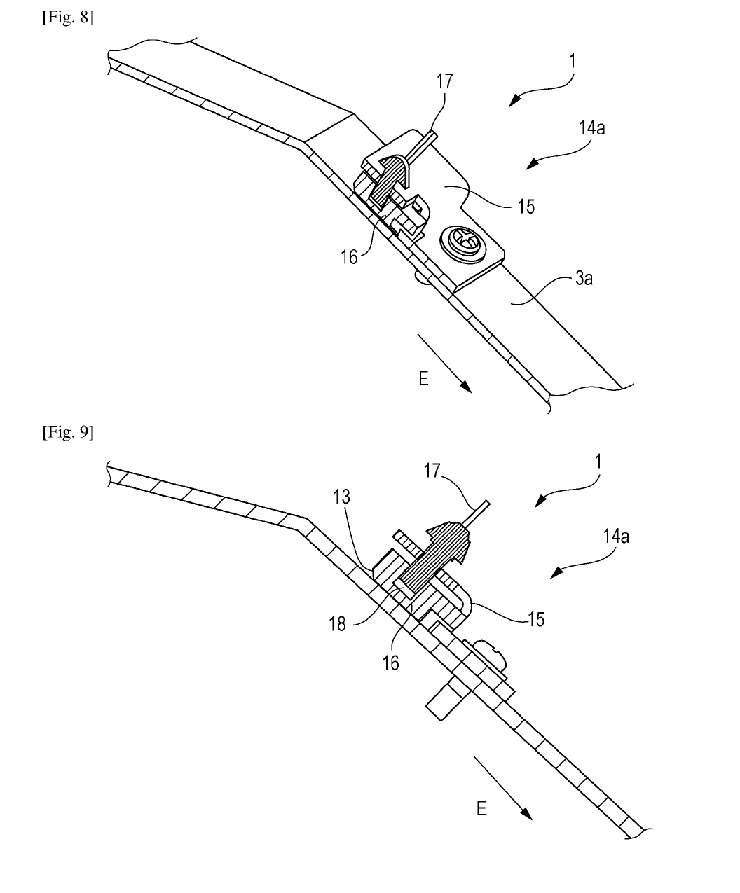

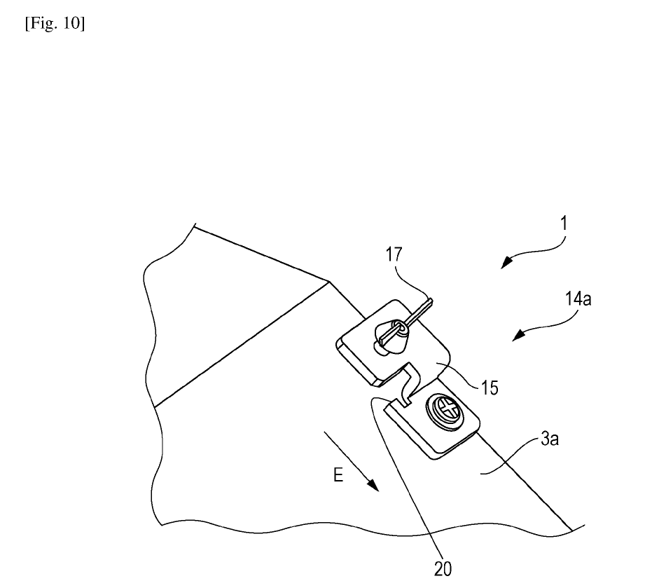

Specifically, FIGS. 3A to 3C are views illustrating the order when the contact portion 7 is attached to the recording apparatus 1 of the embodiment. In addition, FIGS. 4 to 6 are schematic views illustrating the attachment portion 14a in a state where the contact portion 7 of the embodiment is attached. FIG. 4 is a schematic perspective view, FIG. 5 is a schematic perspective cross-sectional view, and FIG. 6 is a schematic side surface cross-sectional view. In addition, FIGS. 7 to 9 are schematic views illustrating the attachment portion 14a in a state where the contact portion 7 of the embodiment is detached. FIG. 7 is a schematic perspective view, FIG. 8 is a schematic perspective cross-sectional view, and FIG. 9 is a schematic side surface cross-sectional view. In addition, FIG. 10 is a schematic perspective view illustrating the attachment portion 14a in a state where the pressing portion 16 is detached from the attachment portion 14a of the embodiment. FIGS. 11 and 12 are schematic perspective views when the pressing portion 16 is viewed from various angles. FIG. 11 is a schematic perspective view from an upper portion side, and FIG. 12 is a schematic perspective view from a lower portion side.

The attachment portions 14a and 14b of the embodiment are formed in a bilaterally symmetrical shape. As illustrated in FIG. 2, in the medium supporting portion 3a, the attachment portions 14a and 14b are provided at a position which corresponds to both end parts in the direction B of the contact portion 7. However, a fastening direction of a thumb screw 17 is common to both attachment portions 14a and 14b. A rotation direction D2 illustrated in FIG. 3C is the fastening direction. A rotation direction D1 illustrated in FIG. 3A is a loosening direction.

The attachment portions 14a and 14b of the embodiment are configured of a base body portion 15 which is fastened by a screw to the medium supporting portion 3a, and the pressing portion 16 which can press the medium supporting portion 3a through the thumb screw 17.

The order when the contact portion 7 is attached to the attachment portions 14a and 14b of the recording apparatus 1 is as follows.

When the contact portion 7 is attached to the medium supporting portion 3a, as illustrated in FIG. 3A, first, a user rotates the thumb screw 17 in the rotation direction D1 and makes a state where a space in which the contact portion 7 is inserted between the medium supporting portion 3a and the pressing portion 16 can be made.

In addition, this state is illustrated in FIGS. 7, 8, and 9.

Next, as illustrated in FIG. 3B, the user makes notch portions 24a and 24b (refer to FIG. 2) of the contact portion 7 pass through the attachment portions 14a and 14b, and moves the contact portion 7 in a direction E which is opposite to the transporting direction A.

In addition, as illustrated in FIGS. 6 and 9, in the pressing portion 16, an inclined surface portion 13 is formed on the upstream side in the direction E, and the pressing portion 16 is easily held when the contact portion 7 is moved in the direction E.

Then, at last, as illustrated in FIG. 3C, the user rotates the thumb screw 17 in the rotation direction D2, and fixes the contact portion 7 to the medium supporting portion 3a by pressing the pressing portion 16 to the contact portion 7.

In addition, this state is illustrated in FIGS. 4, 5, and 6.

In addition, as illustrated in FIGS. 9 and 11, at the upper portion of the pressing portion 16, a hole portion 18 which corresponds to the thumb screw 17 is provided. In addition, as illustrated in FIGS. 11 and 12, at the lower portion of the pressing portion 16, a groove portion 19 which corresponds to a projection portion 20 (refer to FIG. 10) of the base body portion 15 is provided. With this configuration, in the attachment portions 14a and 14b of the embodiment, the pressing portion 16 is unlikely to fall out from the base body portion 15.

In addition, in the embodiment, the contact portion 7 is configured to be biased to the recording medium P by the elastic force of the contact portion 7. However, a configuration in which the elastic force is given to the contact portion 7 by pushing or pulling up the contact portion 7 by using a spring or a cam mechanism, may be employed. A configuration, in which the contact portion 7 can react to the change of the position of the recording medium P, may be employed.

In addition, in the embodiment, a configuration in which the contact portion 7 comes into contact with the surface on the opposite side to the recording surface of the recording medium P is employed, but a configuration in which the contact portion 7 comes into contact with the recording surface of the recording medium P may be employed. In the recording medium P, when the recording surface has higher moisture absorption compared to the surface on the opposite side to the recording surface, there is a concern that the recording surface side will be deformed by moisture absorption. In this case, as the recording surface and the contact portion 7 are brought into contact with each other, it is possible to suppress the moisture absorption on the recording surface side.

In addition, a configuration, in which the contact portion 7 comes into contact with both the recording surface of the recording medium P and the surface on the opposite side to the recording surface, may be employed. In this case, among the contact portion 7 (first contact portion) on the recording surface side and the contact portion 7 (second contact portion) on the surface side on the opposite side to the recording surface, at least one may be biased.

When both contact portions are biased, it is possible to reduce the concern that both the first contact portion and the second contact portion are separated from the recording medium P.

In addition, when the first contact portion is not biased (when only the second contact portion is based), compared to a case where the first contact portion is biased, it is possible to decrease a load given to the recording surface of the recording medium P from the first contact portion. Therefore, it is possible to reduce the concern that a scratch or a stain is generated by the contact with the first contact portion.

In addition, when the second contact portion is not biased (when only the first contact portion is biased), the recording medium P moves upward by mistake due to the contact between the second contact portion and the recording medium P, and it is possible to reduce the concern that recording medium P is separated from the medium supporting portion 3a.

### REFERENCE SIGNS LIST

1 Recording medium

2 Set portion

3a, 3b, 3c Medium supporting portion

4 Recording head

5a, 5b, 5c Heater

6 Carriage

7 Contact portion

8 A pair of transporting rollers (transporting portion)

9 Tension bar

10 Winding portion

11 Transporting mechanism

12 Recording mechanism

13 Inclined surface portion

14a, 14b Attachment portion

15 Base body portion

16 Pressing portion

17 Thumb screw

18 Hole portion

19 Groove portion

20 Projection portion

21 Contact part which is in contact with the recording medium P of the contact portion 7

22 Pre-heating area

23 Contact part which is in contact with the recording medium P of the medium supporting portion 3a

24a, 24b Notch portion

P Recording medium

R1 Roll of the recording medium

R2 Roll of the recording medium

1. A recording apparatus, comprising:
a set portion in which a roll-shaped recording medium is set;
a transporting portion of the recording medium;
a medium supporting portion which supports the recording medium; and
a contact portion which is provided between the set portion and the medium supporting portion in a transporting direction of the recording medium and is biased to come into contact with the recording medium.

2. The recording apparatus according to claim 1,
wherein the contact portion has moisture impermeability.

3. The recording apparatus according to claim 1,
wherein the contact portion has flexibility.

4. The recording apparatus according to any one of claims 1,
wherein the contact portion is made of fluorine at a contact part between the contact portion and the recording medium.

5. The recording apparatus according to any one of claims 1,
wherein the contact portion is attachable and detachable.

6. The recording apparatus according to any one of claims 1, further comprising:
a recording portion which performs recording on the recording medium,
wherein the medium supporting portion includes a pre-heating area in which the recording medium is heated before the recording is performed by the recording portion, and
wherein the contact portion is attached to the pre-heating area.

7. The recording apparatus according to any one of claims 1,
wherein the contact part between the contact portion and the recording medium in the contact portion, and a contact part between the medium supporting portion and the recording medium in the medium supporting portion, are similarly surface-treated.

8. The recording apparatus according to any one of claims 1,
wherein the length of the transporting direction in the contact portion is 50% to 95% of the distance between the recording medium which is set in the set portion and the medium supporting portion.
